(19) United States
(12) Patent Application Publication
(10) Pub. No.: US 2026/0292628 A1
(43) Pub. Date: Sep. 24, 2026

(54) Lower Layer Triggered Mobility Configuration Validation

(71) Applicant: Apple Inc., Cupertino, CA (US)

(72) Inventors: Naveen Kumar R. Palle Venkata, San Diego, CA (US); Alexander Sirotkin, Hod Hasharon, IL (US); Haijing Hu, Los Altos, CA (US); Peng Cheng, Beijing (CN); Yuqin Chen, Beijing (CN); Sethuraman Gurumoothy, San Ramon, CA (US); Zhibin Wu, Los Altos, CA (US); Fangli Xu, Beijing (CN); Ralf Rossbach, Munich (DE); Ping-Heng Kuo, London (GB)

(21) Appl. No.: 19/473,049

(22) PCT Filed: May 5, 2023
(86) PCT No.: PCT/CN2023/092284

§ 371 Date: Oct. 6, 2025

(51) Int. Cl. H04W 36/08; H04W 76/27

(52) U.S. Cl. CPC H04W 36/08; H04W 76/27

(57) ABSTRACT

This disclosure relates to techniques for handling lower layer triggered mobility configuration validation in a wireless communication system. A wireless link may be established by a wireless device and a cellular base station. A radio resource control connection may be established for the wireless link. The wireless device may receive configuration information including lower layer triggered mobility configuration information indicating one or more lower layer triggered mobility candidate cell configurations. The wireless device may evaluate whether the lower layer triggered mobility candidate cell configurations are valid for the wireless device. The wireless device may transmit an indication of whether the lower layer triggered mobility candidate cell configurations are valid for the wireless device.

### FIELD

The present application relates to wireless communications, and more particularly to systems, apparatuses, and methods for handling lower layer triggered mobility configuration validation for in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for handling lower layer triggered mobility (LTM) configuration validation in a wireless communication system.

According to the techniques described herein, a wireless device may be provided with increased processing time to evaluate whether LTM configuration provided to the wireless device by a cellular base station is valid and respond to the cellular base station to confirm the LTM configuration validity. Techniques are described in which the response confirming the LTM configuration validity is included in the same transaction in which other configuration information is confirmed to be applied at the wireless device, as well as in which the response confirming the LTM configuration validity is included in a different transaction than the transaction in which other configuration information is confirmed to be applied at the wireless device.

LTM configuration failure handling techniques are also described herein. The LTM configuration failure handling techniques may include techniques for releasing the current link based on determining that LTM configuration failure has occurred, and reporting cause information for the LTM configuration failure when attempting to re-establish the link. The LTM configuration failure handling techniques may also include techniques for maintaining the current link when LTM configuration failure has occurred, and for reporting the LTM configuration failure (possibly with additional cause information) in a response to the LTM configuration information.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for handling lower layer triggered mobility configuration validation in a wireless communication system, according to some embodiments; and

FIG. 6 illustrates example aspects of a scenario in which LTM candidate configurations are evaluated and responded to in the same transaction as other RRC configuration information, according to some embodiments;

FIGS. 7-9 illustrates example aspects of scenarios in which LTM candidate configurations are evaluated and responded to in a different transaction as other RRC configuration information, according to some embodiments; and

FIGS. 10-11 illustrates example aspects of scenarios in which LTM candidate configuration failures can be reported without releasing a RRC connection, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
3GPP: Third Generation Partnership Project
LTE: Long Term Evolution
NR: New Radio
RAT: Radio Access Technology

### Terms

The following is a glossary of terms that may appear in the present disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.
Wireless Device—any of various types of computer systems or devices that perform wireless communications. A wireless device can be portable (or mobile) or may be stationary or fixed at a certain location. A UE is an example of a wireless device.
Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112, paragraph six, interpretation for that component.

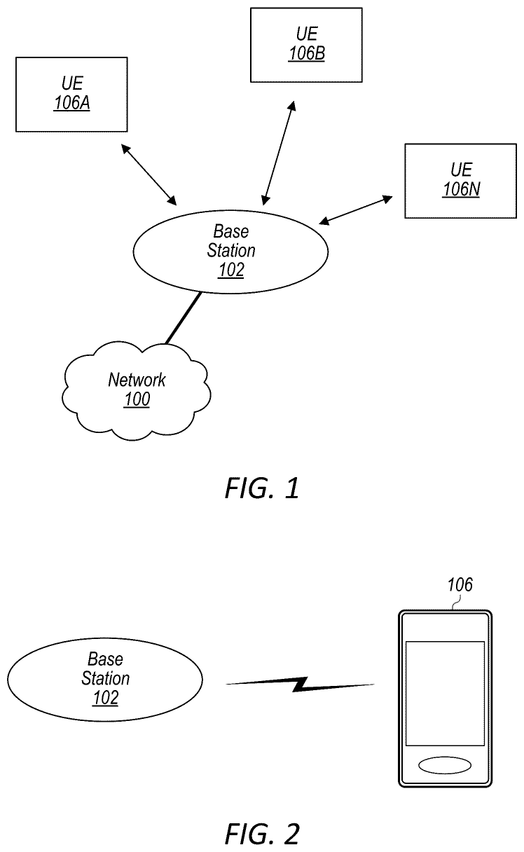

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as LTE, LTE-Advanced (LTE-A), LAA/LTE-U, 5G NR, Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using one or multiple 3GPP cellular communication standards. In some embodiments, the UE 106 may be configured to perform techniques for handling lower layer triggered mobility configuration failure in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of LTE, LTE-A, 5G NR, Wi-Fi, BLUETOOTH™, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or NR, and separate radios for communicating using each of Wi-Fi and BLUETOOTH™. Other configurations are also possible.

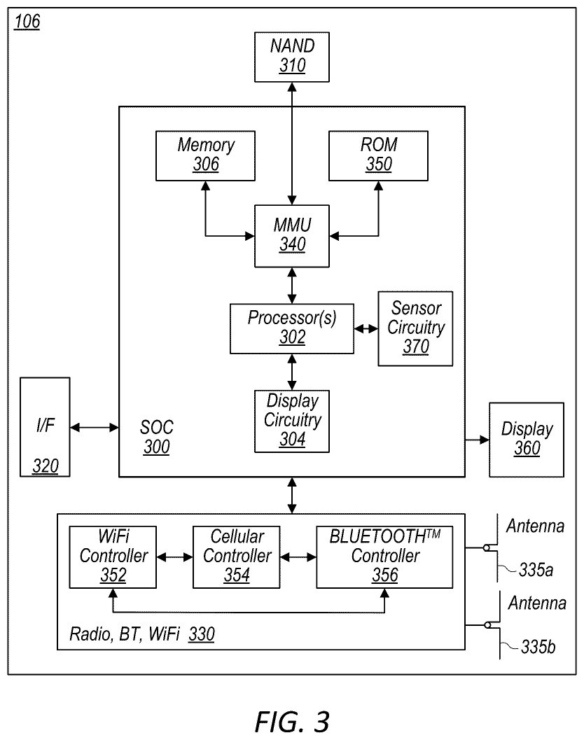

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for handling lower layer triggered mobility configuration failure in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for handling lower layer triggered mobility configuration failure in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

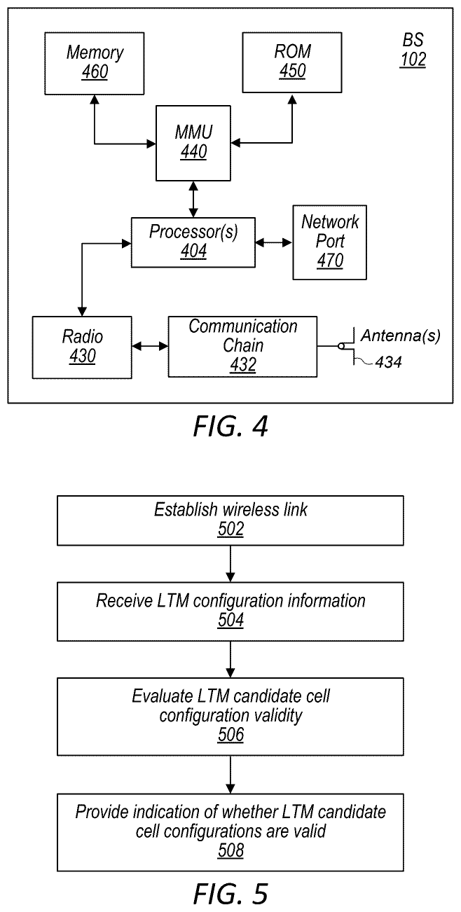

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### FIG. 5—Lower Layer Triggered Mobility Configuration Failure Handling

To support low latency and high reliability mobile services, the importance of being able to quickly shift cells as needed to maintain Quality of Service may be heightened. Techniques for achieving such cell shifting through lower layer signaling, such as 3GPP Release 18 LTM (“lower-layer triggered mobility” or “layer 1 (L1) layer 2 (L2) triggered mobility”) techniques, are under development, and may be expected to reduce latency and improve reliability for at least some wireless devices, according to some embodiments.

One aspect of supporting LTM handover may include provision of LTM configuration information via radio resource control (RRC) signaling in advance of a potential LTM handover. Such configuration could include indicating cell configuration information for one or more candidate cells to which a wireless device may be directed to perform LTM handover. Accordingly, a further aspect of supporting LTM handover may include determining whether the cell configuration information indicated for the LTM candidate cells for a given wireless device is valid for the wireless device, including possible scenarios in which one or more of the LTM candidate cell configurations is not valid for the wireless device. There may be multiple ways in which this could be performed, in various embodiments.

Thus, it may be beneficial to specify techniques for handling lower layer triggered mobility configuration validation, including for handling configuration failure scenarios. To illustrate one such set of possible techniques, FIG. 5 is a flowchart diagram illustrating a method for handling lower layer triggered mobility configuration validation in a wireless communication system, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology, according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

In 504, the wireless device may receive LTM configuration information. The LTM configuration information may be provided via RRC signaling, for example together with other (e.g., non-LTM) RRC configuration information in a RRC reconfiguration message. The LTM configuration information may include information indicating one or more LTM candidate cell configurations. In some embodiments, this may include providing a reference configuration, along with a list of LTM candidate cells and delta configuration information for each such cell. In such a scenario, it may be possible for the wireless device to derive the LTM candidate cell configuration for each of those cells by applying the delta configuration information to the reference configuration information. Other ways of providing the LTM candidate cell configurations are also possible, for example including by providing full configuration information for each of the LTM candidate cells.

In 506, the wireless device may evaluate the LTM candidate cell configurations for validity. This may include checking whether the cell configurations for the LTM candidate cells (e.g., as derived from the reference configuration, in some embodiments) are within the capabilities of the wireless device, among various other possible aspects. In some embodiments, the validation checks may be performed for LTM candidate configurations, as applied only for serving cell, derived from the LTM configuration information of the LTM candidate cells, for example such that configurations for secondary cells for carrier aggregation (CA) or dual connectivity (DC) configurations are not checked using LTM candidate configurations derived from the LTM configuration information. In such a scenario, the CA or DC configuration may be assumed to be applied from the current configuration (e.g., reference configuration may not contain the CA configuration). As another possibility, it may be the case that the validation checks are performed for LTM candidate configurations, as applied for the entire CA/DC configuration, where the current CA/DC configuration is carried over to the target LTM candidate configuration.

In 508, the wireless device may provide an indication of whether the LTM candidate cell configurations are valid to the cellular base station. In some embodiments, the wireless device may also provide an indication confirming that the wireless device has applied the non-LTM configuration information to the cellular base station. According to various embodiments, it may be possible that the indication of whether the LTM candidate cell configurations are valid is provided in the same transaction as the indication confirming that the wireless device has applied the non-LTM configuration information, or that those indications are provided in different transactions (e.g., and potentially transmitted at different times).

For scenarios in which the indication of whether the LTM candidate cell configurations are valid is provided in the same transaction as the indication confirming that the wireless device has applied the non-LTM configuration information, it may be the case that the cellular base station provides an increased RRC processing time, e.g., in comparison to if LTM candidate cell configurations were not provided. For example, the cellular base station may select a timer value for the wireless device to respond to the RRC configuration information based at least in part on whether the RRC configuration information includes LTM configuration information, where the timer value may be longer if the RRC configuration information includes LTM configuration information than if the RRC configuration information does not include LTM configuration information. If the wireless device determines that the LTM configuration information is all valid, it may be the case that the wireless device responds to the RRC configuration information with a RRC configuration complete message, and the indication of whether the LTM candidate cell configurations are valid for the wireless device may be included in the RRC configuration complete message.

If the wireless device determines that the LTM configuration information is not all valid (e.g., at least one LTM candidate cell configuration is invalid for the wireless device), it may be the case that the wireless device releases the RRC connection due to the configuration failure and transmits a RRC re-establishment message. In this scenario, the indication of whether the LTM candidate cell configurations are valid for the wireless device may be included in the RRC re-establishment message. Alternatively, it may be possible for the wireless device to report the LTM configuration failure without releasing the RRC connection. For example, if the wireless device determines that the LTM configuration information is not all valid, it may be the case that the wireless device responds to the RRC configuration information with a RRC configuration complete message, which may indicate that at least one LTM candidate cell configuration is not valid for the wireless device. When at least one LTM candidate cell configuration is not valid for the wireless device, it may be the case that failure cause information is provided to the cellular base station, indicating that at least one LTM candidate cell configuration is not valid for the wireless device, and potentially including information specifically indicating one or more LTM candidate cells on which LTM configuration failure has occurred. Note that such failure cause information could be provided in either or both of the scenario where the wireless device releases the RRC connection or the scenario where the wireless device reports that at least one LTM candidate cell configuration is not valid for the wireless device without releasing the RRC connection.

For scenarios in which the indication of whether the LTM candidate cell configurations are valid is provided in a different transaction as the indication confirming that the wireless device has applied the non-LTM configuration information, the wireless device may transmit a first RRC configuration complete message to the cellular base station in response to the RRC configuration information. The first RRC configuration complete message may indicate that the wireless device has applied non-LTM configuration information from the RRC configuration information. It may be the case that the cellular base station selects the same timer value for the wireless device to provide the first RRC configuration complete message in response to the RRC configuration information regardless of whether LTM configuration information is included in the RRC configuration information, in such a scenario. If the wireless device determines that the LTM configuration information is all valid, it may be the case that the wireless device responds again to the RRC configuration information with a second RRC configuration complete message (e.g., after a later time, due to the processing time to evaluate the validity of the LTM configuration information), and the indication of whether the LTM candidate cell configurations are valid for the wireless device may be included in the second RRC configuration complete message. It may be the case that the cellular base station provides an increased RRC processing time for the second RRC configuration complete message, e.g., in comparison to the processing time provided for the first RRC configuration complete message. For example, the cellular base station may select a timer value associated with confirming LTM configuration information for the wireless device to transmit the second RRC configuration complete message, where the timer value associated with confirming LTM configuration information may be longer than the timer value selected for the first response to the RRC configuration information. Alternatively, it may be the case that there is no explicit processing time constraint for evaluating the LTM configuration information validity.

If the wireless device determines that the LTM configuration information is not all valid (e.g., at least one LTM candidate cell configuration is invalid for the wireless device), it may be the case that the wireless device releases the RRC connection due to the configuration failure and transmits a RRC re-establishment message. In this scenario, the indication of whether the LTM candidate cell configurations are valid for the wireless device may be included in the RRC re-establishment message. Alternatively, it may be possible for the wireless device to report the LTM configuration failure without releasing the RRC connection. For example, if the wireless device determines that the LTM configuration information is not all valid, it may be the case that the wireless device responds to the RRC configuration information with the second RRC configuration complete message, which may indicate that at least one LTM candidate cell configuration is not valid for the wireless device. When at least one LTM candidate cell configuration is not valid for the wireless device, it may be the case that failure cause information is provided to the cellular base station, indicating that at least one LTM candidate cell configuration is not valid for the wireless device, and potentially including information specifically indicating one or more LTM candidate cells on which LTM configuration failure has occurred. Note that such failure cause information could be provided in either or both of the scenario where the wireless device releases the RRC connection or the scenario where the wireless device reports that at least one LTM candidate cell configuration is not valid for the wireless device without releasing the RRC connection.

Note that in scenarios in which a second RRC configuration complete message is provided from the wireless device to the cellular base station (e.g., to confirm that the LTM configuration information is valid or to report that one or more LTM cell configurations are not valid for the wireless device without releasing the RRC connection), it may be the case that the second RRC configuration complete message uses the same transaction identifier (e.g., RRC-TransactionIdentifier ID) as the first RRC configuration complete message. Such use of the same transaction identifier may indicate to the cellular base station that the second RRC configuration complete message is also provided in response to the RRC configuration information, and/or that it is for indicating whether the LTM candidate cell configurations are valid for the wireless device. Alternatively (e.g., if a different transaction identifier is used) or in addition, it could be possible that extra signaling can be provided with the second RRC configuration complete message to indicate that it is for LTM configuration confirmation.

In some embodiments, it may be the case that the cellular base station does not reconfigure the wireless device with further LTM configuration information until LTM configuration information confirmation is received from the wireless device. In a multi-transaction framework, it may be the case that the cellular base station can reconfigure non-LTM configuration parameters prior to receiving the second RRC configuration complete message, or it may be the case that the cellular base station does not reconfigure the wireless device with any further RRC configuration information until LTM configuration information confirmation is received from the wireless device.

Thus, at least according to some embodiments, the method of FIG. 5 may be used to provide a framework for handling LTM configuration validation, including for handling LTM configuration failure scenarios, which may help improve the capability of a cellular network to provide low latency and high reliability mobile services, among other possible benefits at least in some instances.

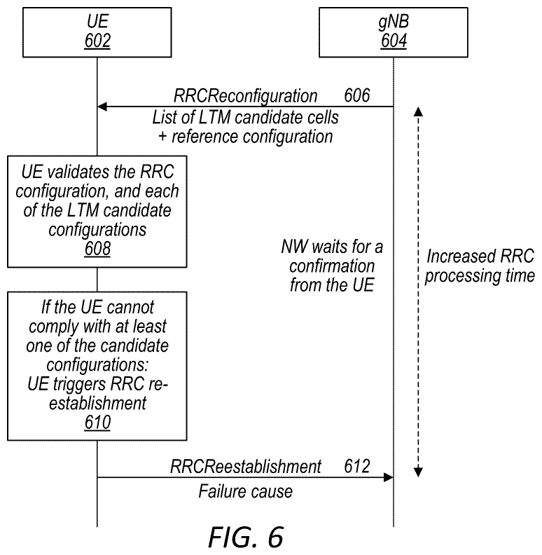

### FIGS. 6-11 and Additional Information

FIGS. 6-11 illustrate further aspects that might be used in conjunction with the method of FIG. 5 if desired. It should be noted, however, that the exemplary details illustrated in and described with respect to FIGS. 6-11 are not intended to be limiting to the disclosure as a whole: numerous variations and alternatives to the details provided herein below are possible and should be considered within the scope of the disclosure.

3GPP objectives for mobility enhancement may include introducing and expanding mechanisms and procedures for layer one (L1) and layer two (L2) inter-cell mobility, for example to provide mobility latency reduction in comparison to RRC/layer three (L3) based mobility techniques.

In such lower-layer triggered mobility (LTM) handover (HO), it may be the case that the centralized unit (CU) will still be the controlling node, even when a distributed unit (DU) triggers the HO. In some embodiments, media access control (MAC) control element (CE) signaling may be used for triggering the HO. The MAC CE may contain the target cell configuration information as a reference. A UE may be able to have multiple candidate configurations, e.g., provided via RRC signaling. There may be multiple possibilities for how and when such a UE validates these configurations, for example including at the time of reception for the RRC configuration information for the LTM handover or at the LTM MAC CE reception time.

It may be possible that when a UE is configured with a candidate LTM configuration, there can be cases where the UE cannot comply with the configuration, or at least some parts of it, e.g., due to a mismatch between UE capabilities and the configuration parameters. Informing the network when this occurs may be important for effective operation, but performing such validation can take some time, and there may potentially be many candidate configurations to be validated. Accordingly, providing techniques for supporting such LTM candidate configuration validation, and for reporting any errors or problems detected with the LTM candidate configurations based on the validation, may be useful. Aspects to consider to potentially improve the efficiency and effectiveness of RRC procedures could include any or all of whether to consider an invalid LTM candidate configuration as a failure condition, whether a UE detecting an invalid LTM candidate configuration should release the current connection, whether a UE can perform such validation and reporting in the background, how to account for the UE processing time to perform the LTM candidate configuration validation, and what actions the network can and cannot perform in view of LTM candidate configuration validation activity by a UE, among other possible considerations, according to various embodiments.

FIGS. 6-11 are signal flow diagrams illustrating example aspects of various possible approaches to handling such considerations, among others, according to various embodiments. FIG. 6 illustrates, in particular, aspects of a scenario in which LTM candidate configurations are evaluated and responded to in the same transaction as any other RRC configuration information provided in a RRC reconfiguration message.

As shown, in 606, a gNB 604 may provide a RRCReconfiguration message to a UE 602. The RRCReconfiguration message may include LTM candidate cell configuration information, for example including a reference configuration and a list of LTM candidate cells with delta configuration information for deriving the LTM candidate configuration for each of the LTM candidate cells. The RRCReconfiguration message may potentially also include other RRC configuration information, for example relating to the current RRC configuration for the UE 602 and the serving cell(s) provided by the gNB 604.

In 608, the UE may validate the configuration information for the current cell, and also each of the LTM candidate configurations. In some embodiments, the UE may evaluate the LTM candidate configuration derived from the reference configuration (e.g., for each LTM candidate cell) and does not check with the current configuration. In some embodiments, the UE may evaluate the LTM candidate configuration derived from the reference configuration only for the serving cell for each LTM candidate. In such a scenario, carrier aggregation (CA) or dual connectivity (DC) configuration may be assumed to be applied from the current configuration (e.g., the reference configuration may not contain the CA/DC configuration).

In 610, if the UE cannot comply with at least one of the candidate configurations, the UE may consider the LTM configuration to have failed and trigger RRC re-establishment. In 612, the UE 602 may proceed to send a RRCReestablishment message to the gNB 604. The RRCReestablishment message may include failure cause information. In some instances, the failure may be reported with cause information indicating reconfigurationFailure, the UE 602 may release the configuration, and apply a default configuration for the RRC re-establishment (e.g., similar to techniques for handling RRC reconfiguration failure unrelated to LTM configuration failure). As another possibility, the failure may be reported with new cause information (e.g., indicating ltm-config-failure, as one possibility), the UE 602 may release the configuration, and apply a default configuration for the RRC re-establishment. In some instances, further information could be provided to indicate for which candidate cell(s) there is failure.

In the scenario of FIG. 6, the network may wait for a confirmation from the UE before attempting further reconfiguration, potentially with a different timer used to determine how long to wait for the confirmation before determining that the RRC reconfiguration has failed than for RRC reconfiguration that does not include LTM configuration information. In other words, the gNB 604 may allow the UE 602 an increased RRC processing time for performing the LTM candidate configuration validation. The timer for the response to the RRCReconfiguration message could have a fixed value, or could depend at least in part on how much LTM candidate configuration information is provided, among various other possibilities.

Note that in an alternative scenario in which the UE 602 validates all of the LTM candidate configurations, it may be the case that the UE provides an RRCReconfigurationComplete message to the gNB 604 in response to the RRCReconfiguration message instead of performing RRC re-establishment, at least in some embodiments.

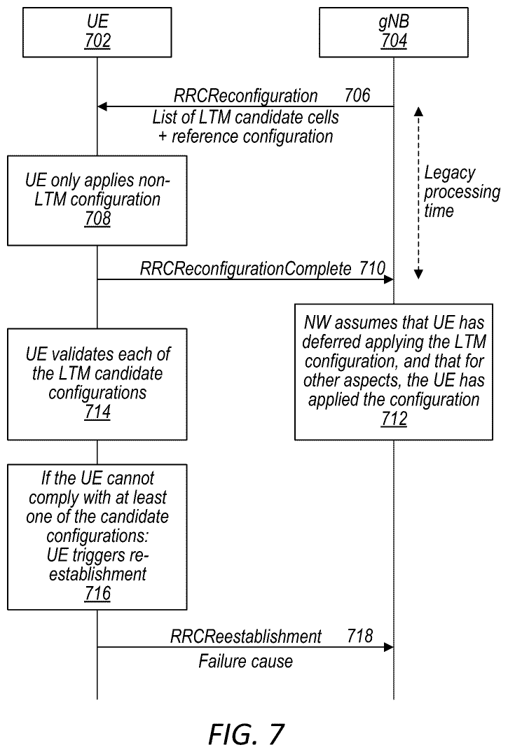

FIG. 7 illustrates aspects of a scenario in which LTM candidate configurations are evaluated and responded to in a separate transaction from non-LTM configuration information. As shown, in 706, a gNB 704 may provide a RRCReconfiguration message to a UE 702. The RRCReconfiguration message may include LTM candidate cell configuration information, for example including a reference configuration and a list of LTM candidate cells with delta configuration information for deriving the LTM candidate configuration for each of the LTM candidate cells. The RRCReconfiguration message may potentially also include other RRC configuration information, for example relating to the current RRC configuration for the UE 702 and the serving cell(s) provided by the gNB 704.

In 708, the UE 702 may apply any non-LTM configuration elements from the RRC reconfiguration information.

In 710, the UE 702 may provide a RRCReconfigurationComplete message to the gNB 704. The UE 702 may send this message without having performed validation on any LTM configuration information provided by the gNB 704; such validation may be deferred. In this scenario, it may be the case that the same timer is used by the gNB 704 to determine how long to wait for the confirmation before determining that the RRC reconfiguration has failed as for RRC reconfiguration that does not include LTM configuration information.

In 712, the network may assume that the UE 702 has deferred applying the LTM configuration, and that for other aspects, the UE 702 has applied the configuration. In 714, the UE 702 may perform validation for the LTM candidate configurations. In some embodiments, the UE may evaluate the LTM candidate configuration derived from the reference configuration (e.g., for each LTM candidate cell) and does not check with the current configuration. In some embodiments, the UE may evaluate the LTM candidate configuration derived from the reference configuration only for the serving cell for each LTM candidate. In such a scenario, CA or DC configuration may be assumed to be applied from the current configuration (e.g., the reference configuration may not contain the CA/DC configuration).

In 716, if the UE cannot comply with at least one of the candidate configurations, the UE may consider the LTM configuration to have failed and trigger RRC re-establishment. In 718, the UE 702 may proceed to send a RRCReestablishment message to the gNB 704. The RRCReestablishment message may include failure cause information. In some instances, the failure may be reported with cause information indicating reconfigurationFailure, the UE 702 may release the configuration, and apply a default configuration for the RRC re-establishment (e.g., similar to techniques for handling RRC reconfiguration failure unrelated to LTM configuration failure). As another possibility, the failure may be reported with new cause information (e.g., indicating ltm-config-failure, as one possibility), the UE 702 may release the configuration, and apply a default configuration for the RRC re-establishment. In some instances, further information could be provided to indicate for which candidate cell(s) there is failure.

In the scenario of FIG. 7, the network may not need to wait for a confirmation of successful validation of the LTM configuration from the UE 702 before attempting further reconfiguration, at least for non-LTM configuration aspects. Alternatively, it may be the case that the network does need to wait for the UE 702 to respond to the LTM configuration information before performing any further RRC reconfiguration. In either case, it may be possible that there is no explicit processing time constraint (e.g., no timer for providing a second RRCReconfigurationComplete message to confirm validation of the LTM configuration). Thus, the gNB 704 may also allow the UE 702 an increased RRC processing time for performing the LTM candidate configuration validation in the scenario of FIG. 7.

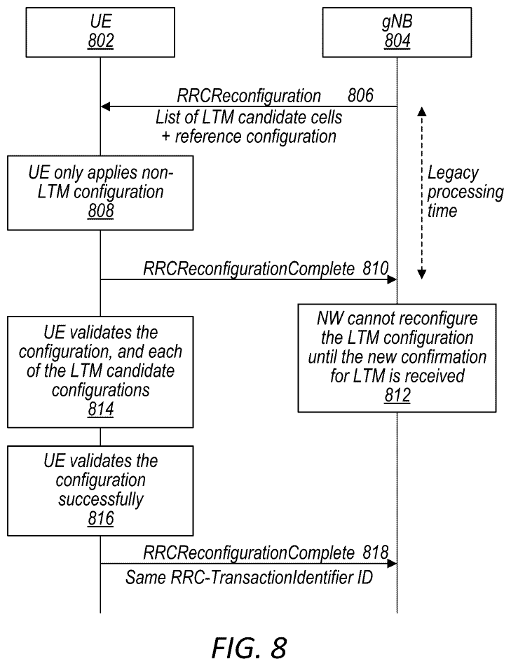

FIG. 8 illustrates aspects of a scenario in which LTM candidate configurations are evaluated and responded to in a separate transaction from non-LTM configuration information, similar to the scenario of FIG. 7, but with successful LTM configuration validation. As shown, in 806, a gNB 804 may provide a RRCReconfiguration message to a UE 802. The RRCReconfiguration message may include LTM candidate cell configuration information and potentially also include other RRC configuration information.

In 808, the UE 802 may apply any non-LTM configuration elements from the RRC reconfiguration information. In 810, the UE 802 may provide a RRCReconfigurationComplete message to the gNB 804, e.g., to confirm that the UE 802 has applied the non-LTM configuration portion from the RRC reconfiguration information.

In 812, the network may assume that the UE 802 has deferred applying the LTM configuration, and that for other aspects, the UE 802 has applied the configuration. Accordingly, it may be the case that the gNB 804 can provide further non-LTM reconfiguration, but cannot further reconfigure the LTM configuration until confirmation for the recent LTM configuration is received. Alternatively, it may be the case that the network needs to wait for the UE 802 to respond to the LTM configuration information before performing any further RRC reconfiguration (e.g., including non-LTM configuration).

In 814, the UE 802 may perform validation for the LTM candidate configurations. In 816, the UE may successfully validate the LTM configurations. In 818, the UE 802 may proceed to send another RRCReconfigurationComplete message to the gNB 804. The second RRCReconfigurationComplete message 818 may include the same RRC-TransactionIdentifer ID as the previous RRCReconfigurationComplete message 810, e.g., so that the gNB 804 can determine that the message is for confirming the LTM configuration portion of the RRCReconfiguration message 806. Alternatively, it could be possible a new transaction identifier is used, and that additional signaling can be used to indicate that the message is for confirming LTM configuration. Note that in the scenario of FIG. 8, it may be possible that there is no explicit processing time constraint (e.g., no timer for providing the second RRCReconfigurationComplete message 818 to confirm validation of the LTM configuration).

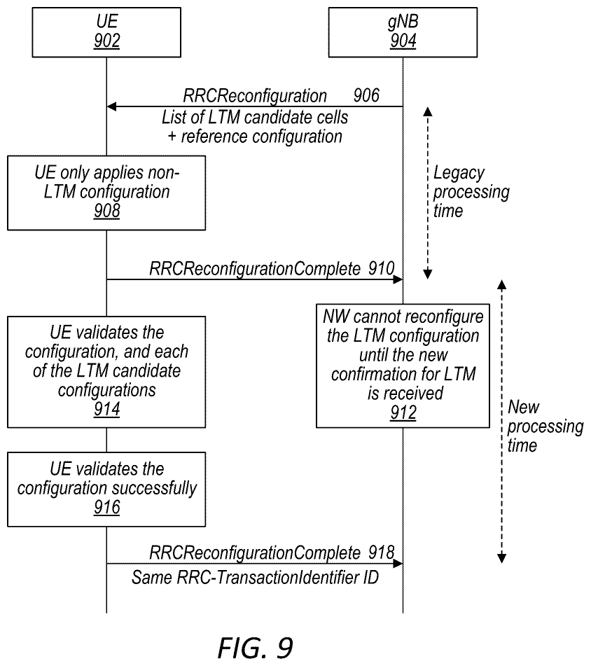

FIG. 9 illustrates aspects of a scenario similar to the scenario of FIG. 8, but an additional RRC processing time requirement enforced. As shown, in 906, a gNB 904 may provide a RRCReconfiguration message to a UE 902. The RRCReconfiguration message may include LTM candidate cell configuration information and potentially also include other RRC configuration information.

In 908, the UE 902 may apply any non-LTM configuration elements from the RRC reconfiguration information. In 910, the UE 902 may provide a RRCReconfigurationComplete message to the gNB 904, e.g., to confirm that the UE 902 has applied the non-LTM configuration portion from the RRC reconfiguration information.

In 912, the network may assume that the UE 902 has deferred applying the LTM configuration, and that for other aspects, the UE 902 has applied the configuration. Accordingly, it may be the case that the gNB 904 can provide further non-LTM reconfiguration, but cannot further reconfigure the LTM configuration until confirmation for the recent LTM configuration is received. Alternatively, it may be the case that the network needs to wait for the UE 902 to respond to the LTM configuration information before performing any further RRC reconfiguration (e.g., including non-LTM configuration).

In 914, the UE 902 may perform validation for the LTM candidate configurations. In 916, the UE may successfully validate the LTM configurations. In 918, the UE 902 may proceed to send another RRCReconfigurationComplete message to the gNB 904. The same RRC-TransactionIdentifer ID may be used, or a new transaction identifier may be used with additional signaling included to indicate that the message is for confirming LTM configuration.

As shown, in contrast to the scenario of FIG. 8, a new processing time constraint may be enforced for completing validation of the LTM configuration. For example, a timer may be defined and used to limit the amount of time the UE 902 has to provide the second RRCReconfigurationComplete message 918 to confirm validation of the LTM configuration, or the gNB 902 may determine that the LTM configuration has failed. The timer for the LTM configuration confirmation could have a fixed value, or could depend at least in part on how much LTM candidate configuration information is provided, among various other possibilities.

As previously noted herein, it may be possible that a UE releases the link and performs RRC re-establishment when LTM validation fails, for example as in the scenarios of FIGS. 6-7. It may also be possible that when LTM validation fails, as long as the failure is only for the LTM configuration, that the UE can maintain its current link, and report back with a new RRC message or use an existing RRC reconfiguration complete message with new information about the failure.

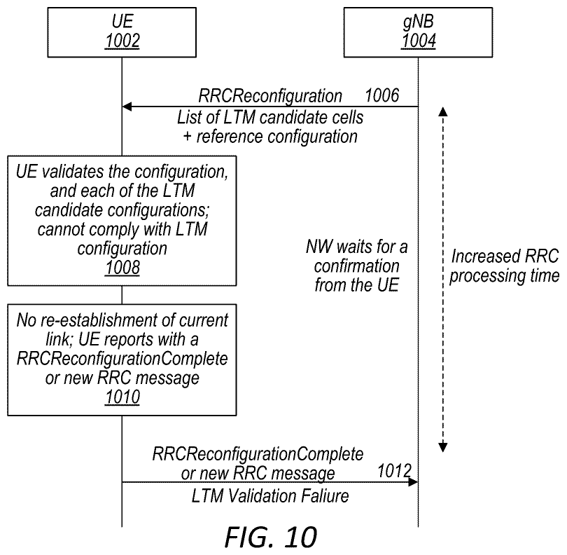

FIG. 10 illustrates example aspects of such a scenario, where LTM candidate configurations are evaluated and responded to in the same transaction as non-LTM configuration information. As shown, in 1006, a gNB 1004 may provide a RRCReconfiguration message to a UE 1002. The RRCReconfiguration message may include LTM candidate cell configuration information, for example including a reference configuration and a list of LTM candidate cells with delta configuration information for deriving the LTM candidate configuration for each of the LTM candidate cells. The RRCReconfiguration message may potentially also include other RRC configuration information, for example relating to the current RRC configuration for the UE 1002 and the serving cell(s) provided by the gNB 1004.

In 1008, the UE may validate the configuration information for the current cell, and also each of the LTM candidate configurations, and may determine that the UE cannot comply with the LTM configuration. In 1010, even though the UE cannot comply with at least one of the candidate configurations, the UE may not re-establish the current link, but may instead report the LTM configuration failure with a new RRC message or new information in a RRCReconfigurationComplete message.

In 1012, the UE 1002 may proceed to send the new RRC message or the RRCReconfigurationComplete message with the new information to the gNB 1004. The new RRC message or the RRCReconfigurationComplete message may include failure cause information indicating LTM validation failure, and possibly indicating for which candidate cell(s) there is LTM validation failure.

In the scenario of FIG. 10, the network may wait for a confirmation from the UE before attempting further reconfiguration, potentially with a different timer used to determine how long to wait for the confirmation before determining that the RRC reconfiguration has failed than for RRC reconfiguration that does not include LTM configuration information. In other words, the gNB 1004 may allow the UE 1002 an increased RRC processing time for performing the LTM candidate configuration validation. The timer for the response to the RRCReconfiguration message could have a fixed value, or could depend at least in part on how much LTM candidate configuration information is provided, among various other possibilities.

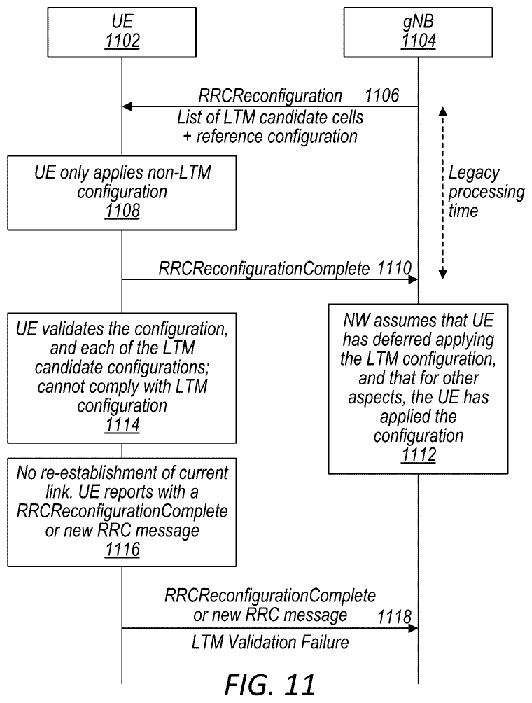

FIG. 11 illustrates example aspects of another scenario in which the current link can be maintained when LTM validation fails, where LTM candidate configurations are evaluated and responded to in a separate transaction from non-LTM configuration information. As shown, in 1106, a gNB 1104 may provide a RRCReconfiguration message to a UE 1102. The RRCReconfiguration message may include LTM candidate cell configuration information and potentially also include other RRC configuration information.

In 1108, the UE 1102 may apply any non-LTM configuration elements from the RRC reconfiguration information. In 1110, the UE 1102 may provide a RRCReconfigurationComplete message to the gNB 1104, e.g., to confirm that the UE 1102 has applied the non-LTM configuration portion from the RRC reconfiguration information.

In 1112, the network may assume that the UE 1102 has deferred applying the LTM configuration, and that for other aspects, the UE 1102 has applied the configuration. Accordingly, it may be the case that the gNB 1104 can provide further non-LTM reconfiguration, but cannot further reconfigure the LTM configuration until confirmation for the recent LTM configuration is received. Alternatively, it may be the case that the network needs to wait for the UE 1102 to respond to the LTM configuration information before performing any further RRC reconfiguration (e.g., including non-LTM configuration).

In 1114, the UE 1102 may perform validation for the LTM candidate configurations, and may determine that the UE cannot comply with the LTM configuration. In 1116, even though the UE cannot comply with at least one of the candidate configurations, the UE may not re-establish the current link, but may instead report the LTM configuration failure with a new RRC message or new information in a RRCReconfigurationComplete message. In 1118, the UE 1102 may proceed to send the new RRC message or the RRCReconfigurationComplete message with the new information to the gNB 1104. The new RRC message or the RRCReconfigurationComplete message may include failure cause information indicating LTM validation failure, and possibly indicating for which candidate cell(s) there is LTM validation failure.

For the scenarios of FIGS. 11-12, and/or for other embodiments in which the current link can be maintained when LTM validation failure occurs, it may be the case that the UE does not save any of the LTM configuration information after LTM configuration failure. In this case, the network may need to provide the complete LTM configuration information again, for example potentially including the reference configuration information. Alternatively, in some embodiments, the UE may not save the LTM configuration information only of the reported “index” where it failed. In this case, it may be possible that the network only needs to provide that specific LTM configuration information again.

In the following further exemplary embodiments are provided.

One set of embodiments may include a method, comprising: by a wireless device: receiving radio resource control (RRC) configuration information including lower layer triggered mobility (LTM) configuration information indicating one or more LTM candidate cell configurations; evaluating whether the LTM candidate cell configurations are valid for the wireless device; and transmitting an indication of whether the LTM candidate cell configurations are valid for the wireless device.

According to some embodiments, the indication indicates that at least one LTM candidate cell configuration is not valid for the wireless device through failure cause information provided by the wireless device in a RRC re-establishment message.

According to some embodiments, the indication indicates that at least one LTM candidate cell configuration is not valid for the wireless device through a RRC configuration complete message.

According to some embodiments, the method further comprises, by the wireless device: transmitting an indication of one or more LTM candidate cells on which LTM configuration failure has occurred.

According to some embodiments, the method further comprises, by the wireless device: transmitting a first RRC configuration complete message to the cellular base station in response to the RRC configuration information, wherein the first RRC configuration complete message indicates that the wireless device has applied non-LTM configuration information from the RRC configuration information; and transmitting a second RRC configuration complete message to the cellular base station in response to the RRC configuration information, wherein the second RRC configuration complete message indicates whether the LTM candidate cell configurations are valid for the wireless device.

According to some embodiments, the second RRC configuration complete message includes information indicating that the second RRC configuration complete message is for LTM configuration confirmation.

According to some embodiments, the method further comprises, by the wireless device: transmitting a RRC configuration complete message to the cellular base station in response to the RRC configuration information, wherein the RRC configuration complete message indicates that the wireless device has applied non-LTM configuration information from the RRC configuration information and also indicates whether the LTM candidate cell configurations are valid for the wireless device.

According to some embodiments, evaluating whether the LTM candidate cell configurations are valid for the wireless device includes evaluating LTM candidate configurations derived from the LTM configuration information for all LTM candidate cells.

According to some embodiments, evaluating whether the LTM candidate cell configurations are valid for the wireless device includes evaluating LTM candidate configurations derived from the LTM configuration information only for serving cell LTM candidate cells.

Another set of embodiments may include an apparatus, comprising: a processor configured to cause a wireless device to perform steps of the method of any of the preceding examples.

Yet another set of embodiments may include a wireless device, comprising: an antenna; a radio operably coupled to the antenna; and one or more processors operably coupled to the radio; wherein the wireless device is configured to perform steps of the method of any of the preceding examples.

Still another set of embodiments may include a method, comprising: by a cellular base station: transmitting radio resource control (RRC) configuration information including lower layer triggered mobility (LTM) configuration information indicating one or more LTM candidate cell configurations; and receiving an indication of whether the LTM candidate cell configurations are valid for the wireless device.

According to some embodiments, the indication indicates that at least one LTM candidate cell configuration is not valid for the wireless device through failure cause information provided by the wireless device in a RRC re-establishment message.

According to some embodiments, the indication indicates that at least one LTM candidate cell configuration is not valid for the wireless device through a RRC configuration complete message.

According to some embodiments, the method further comprises, by the cellular base station: receiving an indication of one or more LTM candidate cells on which LTM configuration failure has occurred.

According to some embodiments, the method further comprises, by the cellular base station: receiving a first RRC configuration complete message from the wireless device in response to the RRC configuration information, wherein the first RRC configuration complete message indicates that the wireless device has applied non-LTM configuration information from the RRC configuration information; and receiving a second RRC configuration complete message from the wireless device in response to the RRC configuration information, wherein the second RRC configuration complete message indicates whether the LTM candidate cell configurations are valid for the wireless device.

According to some embodiments, the second RRC configuration complete message includes information indicating that second RRC configuration complete message is for LTM configuration confirmation.

According to some embodiments, the method further comprises, by the cellular base station: receiving a RRC configuration complete message from the wireless device in response to the RRC configuration information, wherein the RRC configuration complete message indicates that the wireless device has applied non-LTM configuration information from the RRC configuration information and also indicates whether the LTM candidate cell configurations are valid for the wireless device.

According to some embodiments, the method further comprises, by the cellular base station: selecting one or more timer values for the wireless device to respond to the RRC configuration information based at least in part on the RRC configuration information including LTM configuration information.

A still further set of embodiments may include a cellular base station, comprising: one or more processors; and a memory having instructions stored thereon, which when executed by the one or more processors, perform steps of the method of any of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processor operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processor configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving radio resource control (RRC) configuration information including lower layer triggered mobility (LTM) configuration information indicating one or more LTM candidate cell configurations;
evaluating whether the LTM candidate cell configurations are valid for a wireless device; and
transmitting an indication of whether the LTM candidate cell configurations are valid for the wireless device.

2. The method of claim 1,
wherein the indication indicates that at least one LTM candidate cell configuration is not valid for the wireless device through failure cause information provided by the wireless device in a RRC re-establishment message.

3. The method of claim 1,
wherein the indication indicates that at least one LTM candidate cell configuration is not valid for the wireless device through a RRC configuration complete message.

4. The method of claim 1, wherein the method further comprises
transmitting an indication of one or more LTM candidate cells on which LTM configuration failure has occurred.

5. The method of claim 1, wherein the method further comprises
transmitting a first RRC configuration complete message to a cellular base station in response to the RRC configuration information, wherein the first RRC configuration complete message indicates that the wireless device has applied non-LTM configuration information from the RRC configuration information; and
transmitting a second RRC configuration complete message to the cellular base station in response to the RRC configuration information, wherein the second RRC configuration complete message indicates whether the LTM candidate cell configurations are valid for the wireless device.

6. The method of claim 5,
wherein the second RRC configuration complete message includes information indicating that the second RRC configuration complete message is for LTM configuration confirmation.

7. The method of claim 1, wherein the method further comprises
transmitting a RRC configuration complete message to a cellular base station in response to the RRC configuration information, wherein the RRC configuration complete message indicates that the wireless device has applied non-LTM configuration information from the RRC configuration information and also indicates whether the LTM candidate cell configurations are valid for the wireless device.

8. The method of claim 1,
wherein evaluating whether the LTM candidate cell configurations are valid for the wireless device includes evaluating LTM candidate configurations derived from the LTM configuration information for all LTM candidate cells.

9. The method of claim 1,
wherein evaluating whether the LTM candidate cell configurations are valid for the wireless device includes evaluating LTM candidate configurations derived from the LTM configuration information only for serving cell LTM candidate cells.

10. (canceled)

11. (canceled)

12. A method, comprising:
by a cellular base station:
transmitting, to a wireless device, radio resource control (RRC) configuration information including lower layer triggered mobility (LTM) configuration information indicating one or more LTM candidate cell configurations; and
receiving an indication of whether the LTM candidate cell configurations are valid for the wireless device.

13. The method of claim 12,
wherein the indication indicates that at least one LTM candidate cell configuration is not valid for the wireless device through failure cause information provided by the wireless device in a RRC re-establishment message.

14. The method of claim 12,
wherein the indication indicates that at least one LTM candidate cell configuration is not valid for the wireless device through a RRC configuration complete message.

15. The method of claim 12, wherein the method further comprises, by the cellular base station:
receiving an indication of one or more LTM candidate cells on which LTM configuration failure has occurred.

16. The method of claim 12, wherein the method further comprises, by the cellular base station:
receiving a first RRC configuration complete message from the wireless device in response to the RRC configuration information, wherein the first RRC configuration complete message indicates that the wireless device has applied non-LTM configuration information from the RRC configuration information; and
receiving a second RRC configuration complete message from the wireless device in response to the RRC configuration information, wherein the second RRC configuration complete message indicates whether the LTM candidate cell configurations are valid for the wireless device.

17. The method of claim 16,
wherein the second RRC configuration complete message includes information indicating that second RRC configuration complete message is for LTM configuration confirmation.

18. The method of claim 12, wherein the method further comprises, by the cellular base station:
receiving a RRC configuration complete message from the wireless device in response to the RRC configuration information, wherein the RRC configuration complete message indicates that the wireless device has applied non-LTM configuration information from the RRC configuration information and also indicates whether the LTM candidate cell configurations are valid for the wireless device.

19. The method of claim 12, wherein the method further comprises, by the cellular base station:
selecting one or more timer values for the wireless device to respond to the RRC configuration information based at least in part on the RRC configuration information including LTM configuration information.

20. (canceled)

21. An apparatus, comprising:
a processor configured to, when executing instructions stored in a memory, perform operations comprising:
receiving radio resource control (RRC) configuration information including lower layer triggered mobility (LTM) configuration information indicating one or more LTM candidate cell configurations;
evaluating whether the LTM candidate cell configurations are valid for a wireless device; and
transmitting an indication of whether the LTM candidate cell configurations are valid for the wireless device.

22. The apparatus of claim 21,
wherein the indication indicates that at least one LTM candidate cell configuration is not valid for the wireless device through failure cause information provided by the wireless device in a RRC re-establishment message.

23. The apparatus of claim 21,
wherein the indication indicates that at least one LTM candidate cell configuration is not valid for the wireless device through a RRC configuration complete message.
